(19) United States
(12) Patent Application Publication
(10) Pub. No.: US 2020/0112715 A1
(43) Pub. Date: Apr. 9, 2020

(54) HISTORY-BASED MOTION VECTOR PREDICTION FOR INTER PREDICTION CODING

(71) Applicant: QUALCOMM Incorporated, San Diego, CA (US)

(72) Inventors: Chao-Hsiung HUNG, San Diego, CA (US); Chun-Chi CHEN, San Diego, CA (US); Wei-Jung CHIEN, San Diego, CA (US); Marta KARCZEWICZ, San Diego, CA (US)

(21) Appl. No.: 16/591,417

(22) Filed: Oct. 2, 2019

Related U.S. Application Data
(60) Provisional application No. 62/742,115, filed on Oct. 5, 2018.

(51) Int. Cl. H04N 19/105; H04N 19/159; H04N 19/423; H04N 19/176

(52) U.S. Cl. CPC H04N 19/105; H04N 19/176; H04N 19/423; H04N 19/159

(57) ABSTRACT

A method of coding (e.g., encoding or decoding) video data that includes coding a first block of video data using an inter prediction coding mode where coding the first block using the inter prediction coding mode comprises: constructing a list of candidate motion vectors for coding the first block using the inter prediction coding mode, identifying at least one motion vector predictor from among the list of candidate motion vectors, and generating a reconstructed motion vector based on the at least one motion vector predictor. The method of coding further includes adding the reconstructed MV to a history-based motion vector prediction (HMVP) candidate list and adding, to the HMVP candidate list, at least a second motion vector associated with construction of the list of candidate motion vectors.

This application claims the benefit of U.S. Provisional Application No. 62/742,115, filed Oct. 5, 2018, the entire content of which is hereby incorporated by reference.

### TECHNICAL FIELD

This disclosure relates to video encoding and/or video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for inter prediction and motion vector reconstruction in video coding. More specifically, this disclosure describes techniques for constructing candidate list(s) for inter prediction motion vector(s) also referred to as, “inter prediction motion vector candidate list construction,” based on history-based motion vector prediction (HMVP) under a particular inter prediction coding mode. The techniques of this disclosure may be used with any of the existing video codecs, such as High Efficiency Video Coding (HEVC), or be an efficient coding tool in any future video coding standards, such as H.266/Versatile Video Coding (VVC).

In one example, a method of coding video data includes coding a first block of video data using an inter prediction coding mode where coding of the first block using the inter prediction coding mode includes constructing a list of candidate motion vectors for coding the first block using the inter prediction coding mode, identifying at least one motion vector predictor from among the list of candidate motion vectors, and generating a reconstructed motion vector based on the at least one motion vector predictor. The method further includes adding the reconstructed motion vector to a history-based motion vector prediction (HMVP) candidate list and adding, to the HMVP candidate list, a second motion vector associated with construction of the list of candidate motion vectors.

In another example, a coding device for encoding or for decoding video data includes a buffer memory configured to store pictures of the video data and at least one processor, implemented in circuitry, that is in communication with the buffer memory and is configured to construct a list of candidate motion vectors for coding a first block using an inter prediction coding mode, identify at least one motion vector predictor from among the list of candidate motion vectors, generate a reconstructed motion vector based on the at least one motion vector predictor, add the reconstructed motion vector to a history-based motion vector prediction (HMVP) candidate list, and add, to the HMVP candidate list, a second motion vector associated with construction of the list of candidate motion vectors.

In yet another example, an apparatus configured to encode or decode video data includes means for constructing a list of candidate motion vectors for coding a first block using an inter prediction coding mode, means for identifying at least one motion vector predictor from among the list of candidate motion vectors, means for generating a reconstructed motion vector based on the at least one motion vector predictor, means for adding the reconstructed motion vector to a history-based motion vector prediction (HMVP) candidate list, and means for adding, to the HMVP candidate list, a second motion vector associated with construction of the list of candidate motion vectors.

In yet another example, a computer-readable storage medium stores instructions that, when executed, causes at least one processor configured to code video data to construct a list of candidate motion vectors for coding a first block using an inter prediction coding mode, identify at least one motion vector predictor from among the list of candidate motion vectors, generate a reconstructed motion vector based on the at least one motion vector predictor, add the reconstructed motion vector to a history-based motion vector prediction (HMVP) candidate list, and add, to the HMVP candidate list, a second motion vector associated with construction of the list of candidate motion vectors.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may perform the techniques of this disclosure.

FIGS. 2A and 2B are conceptual diagrams illustrating an example quadtree binary tree (QTBT) structure, and a corresponding coding tree unit (CTU).

FIG. 3 is a block diagram illustrating an example video encoder that may perform the techniques of this disclosure.

FIG. 4 is a block diagram illustrating an example video decoder that may perform the techniques of this disclosure.

FIG. 5A is a conceptual diagram showing spatial neighboring candidates for merge mode.

FIG. 5B is a conceptual diagram showing spatial neighboring candidates for advanced motion vector prediction (AMVP) mode.

FIG. 6A is a conceptual diagram showing a temporal motion vector predictor candidate.

FIG. 6B is a conceptual diagram showing motion vector scaling.

FIG. 7 is a flowchart showing a decoding flowchart using history-based motion vector predictor (HMVP).

FIG. 8A is a conceptual diagram showing a table update process for a first-in, first-out (FIFO) buffer for HMVP.

FIG. 8B is a conceptual diagram showing a table update process for a constraint FIFO buffer for HMVP.

FIG. 9 illustrates an exemplary selection priority among spatial neighboring motion vectors (MVs) and temporal neighboring MVs for utilization as MV candidates.

FIG. 10 is a flowchart illustrating example operations of a video encoder operating in accordance with the mechanism(s) and/or technique(s) of this disclosure.

FIG. 11 is a flowchart illustrating example operations of a video decoder operating in accordance with the mechanism(s) and/or technique(s) of this disclosure.

### DETAILED DESCRIPTION

In general, this disclosure describes techniques for inter prediction and motion vector reconstruction in video coding. More specifically, this disclosure describes techniques for constructing candidate list(s) for inter prediction motion vector(s) also referred to as, “inter prediction motion vector candidate list construction,” based on history-based motion vector prediction (HMVP) under various inter prediction modes such as, for example, advanced motion vector prediction (AMVP), merge mode, affine inter mode, and/or affine merge mode. The techniques of this disclosure may be used with any of the existing video codecs, such as High Efficiency Video Coding (HEVC), or be an efficient coding tool in any future video coding standards, such as H.266/Versatile Video Coding (VVC) or MPEG-5 Essential Video Coding (EVC) as well as future proprietary video coding implementations, techniques, or schemes.

Various techniques in this disclosure may be described with reference to a video coder, which is intended to be a generic term that can refer to either a video encoder or a video decoder. Unless explicitly stated otherwise, it should not be assumed that techniques described with respect to a video encoder or a video decoder cannot be performed by the other of a video encoder or a video decoder. For example, in many instances, a video decoder performs the same, or sometimes a reciprocal, coding technique as a video encoder in order to decode encoded video data. In many instances, a video encoder also includes a video decoding loop, and thus the video encoder performs video decoding as part of encoding video data. Thus, unless stated otherwise, the techniques described in this disclosure with respect to a video decoder may also be performed by a video encoder, and vice versa.

This disclosure may also use terms such as current layer, current block, current picture, current slice, etc. In the context of this disclosure, the term current is intended to identify a layer, block, picture, slice, etc. that is currently being coded (e.g., encoded or decoded), as opposed to, for example, previously coded layers, blocks, pictures, and slices or yet to be coded blocks, pictures, and slices.

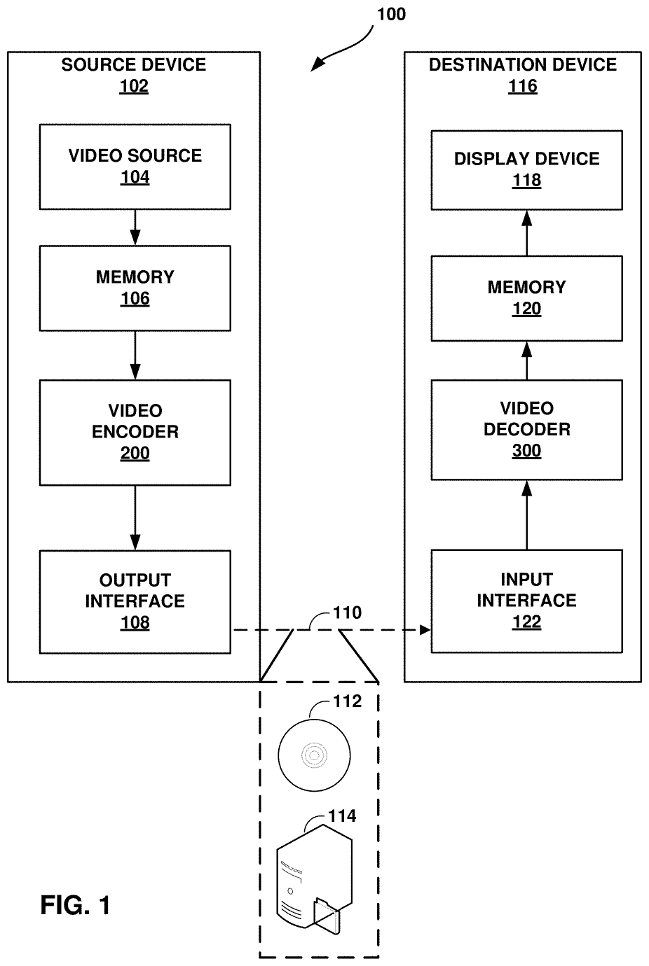

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

FIG. 1 illustrates a system 100 including a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, tablet computers, set-top boxes, telephone handsets such smartphones, televisions, cameras, display devices, digital media players, video gaming consoles, video streaming device, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for history-based motion vector prediction for various inter prediction coding modes. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than including an integrated display device.

System 100 as shown in FIG. 1 is merely one example. In general, any digital video encoding and/or decoding device may perform techniques for history-based motion vector prediction for inter prediction such as AMVP. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, devices 102, 116 may operate in a substantially symmetrical manner such that each of devices 102, 116 include video encoding and decoding components. Hence, system 100 may support one-way or two-way video transmission between video devices 102, 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some example, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although shown separately from video encoder 200 and video decoder 300 in this example, it should be understood that video encoder 200 and video decoder 300 may also respectively include memory internal the video encoder 200 and video decoder 300 for functionally similar or equivalent purposes. Furthermore, memories 106, 120 may store encoded video data, e.g., output from video encoder 200 and input to video decoder 300. In some examples, portions of memories 106, 120 may be allocated as one or more still image and/or video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may modulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 116. Similarly, destination device 116 may access encoded data from storage device 116 via input interface 122. Storage device 116 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., DSL, cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receiver, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., storage device 112, file server 114, or the like). The encoded video bitstream computer-readable medium 110 may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a cathode ray tube (CRT), a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable processing circuitry configured for encoder and/or decoder operation/functionality. Examples of such encoder and/or decoder configured processing circuitry, include but are not limited to, one or more microprocessors, digital signal processor(s) (DSPs), application specific integrated circuit(s) (ASICs), field programmable gate arrays (FPGAs), discrete logic, software, hardware, firmware and/or any combinations thereof. When the techniques are implemented partially in software, a device may store instructions for the software in a suitable, non-transitory computer-readable medium and execute the instructions in hardware using one or more processors (e.g., processing circuitry) to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions.

In addition, a video coding standard, namely High Efficiency Video Coding (HEVC) or ITU-T H.265 (G. J. Sullivan, J.-R. Ohm, W.-J. Han, T. Wiegand “Overview of the High Efficiency Video Coding (HEVC) Standard,” IEEE Transactions on Circuits and Systems for Video Technology, vol. 22, no. 12. pp. 1649-1668, December 2012), including its range extension, multiview extension (MV-HEVC) and scalable extension (SHVC), has been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG).

An HEVC draft specification, and referred to as HEVC WD hereinafter, is available from http://phenix.int-evry.fr/jct/doc_end_user/documents/14_Vienna/wg11/JCTVC-N1003-v1.zip. The latest version of the Final Draft of International Standard (FDIS) of HEVC can be found in http://phenix.it-sudparis.eu/jct/doc_end_user/documents/12_Geneva/wg11/JCTVC-L1003-v34.zip.

ITU-T VCEG (Q6/16) and ISO/IEC MPEG (JTC 1/SC 29/WG 11) are studying the potential need for standardization of future video coding technology with a compression capability that significantly exceeds that of the current HEVC standard (including its current extensions and near-term extensions for screen content coding and high-dynamic-range coding). The groups are working together on this exploration activity in a joint collaboration effort known as the Joint Video Exploration Team (JVET) to evaluate compression technology designs proposed by their experts in this area. The JVET first met during 19-21 Oct. 2015. And the latest version of reference software, i.e., Joint Exploration Model 7 (JEM 7) could be downloaded from: https://jvet.hhi.fraunhofer.de/svn/svn_HMJEMSoftware/tags/HM-16.6-JEM-7.2/. An algorithm description of Joint Exploration Test Model 7 (JEM-7) is described in J. Chen, E. Alshina, G. J. Sullivan, J.-R. Ohm, J. Boyce, “Algorithm Description of Joint Exploration Test Model 7”, JVET-G1001, July 2017.

An early draft for new video coding standard, referred to as the H.266/Versatile Video Coding (VVC) standard, is available in the document JVET-J1001 “Versatile Video Coding (Draft 1)” by Benjamin Bross, and its algorithm description is available in the document JVET-J1002 “Algorithm description for Versatile Video Coding and Test Model 1 (VTM 1)” by Jianle Chen and Elena Alshina. The techniques of this disclosure, however, are not limited to any particular coding standard.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry implementations and/or standards, such as the Joint Exploration Test Model (JEM) and/or VVC. The techniques of this disclosure, however, are not limited to any particular coding standard, implementation, and/or scheme.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and/or decoding) of pictures to include the process of encoding and/or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to examples of JEM and/or VVC. According to examples of JEM/VVC, a video coder (such as video encoder 200) partitions a picture into a plurality of coding tree units (CTUs). Video encoder 200 may partition a CTU according to a tree structure, such as a quadtree-binary tree (QTBT) structure. The QTBT structure of examples of JEM/VVC removes the concepts of multiple partition types, such as the separation between CUs, PUs, and TUs of HEVC. A QTBT structure of examples of JEM/VVC includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In some examples, video encoder 200 and video decoder 300 may use a single QTBT structure to represent each of the luminance and chrominance components, while in other examples, video encoder 200 and video decoder 300 may use two or more QTBT structures, such as one QTBT structure for the luminance component and another QTBT structure for both chrominance components (or two QTBT structures for respective chrominance components).

Video encoder 200 and video decoder 300 may be configured to use quadtree partitioning per HEVC, QTBT partitioning according to examples of JEM/VVC, and/or other partitioning structures. For purposes of explanation, the description of the techniques of this disclosure is presented with respect to QTBT partitioning. However, it should be understood that the techniques of this disclosure may also be applied to video coders configured to use quadtree partitioning, and/or other types of partitioning as well.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16) Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

To perform intra-prediction, video encoder 200 may select an intra-prediction mode to generate the prediction block. JEM provides sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using AMVP mode, merge mode, affine inter mode, and/or affine merge mode.

Following prediction, such as intra-prediction of a block or inter-prediction of a block using, for example, one of the inter prediction modes referenced above (e.g., AMVP mode, merge mode, affine inter mode, and/or affine merge mode), video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the coefficients, providing further compression. By performing the quantization process, video encoder 200 may reduce the bit depth associated with some or all of the coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) coefficients at the front (e.g., beginning) of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and/or sequence-based syntax data, to video decoder 300, e.g., in a picture header, a block header, a slice header, or other syntax data, such as parameter set data including, but not limited to, a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

As will be explained in more detail below, video encoder 200 and/or video decoder 300 may be configured to code a first block of video data using a particular inter prediction mode such as, for example, AMVP mode of inter prediction coding where coding the first block using the AMVP mode includes video encoder 200 and/or video decoder 300 being configured to construct a list of candidate motion vectors for coding the first block using the AMVP mode, identify at least one MV predictor from among the list of candidate motion vectors, and generate a reconstructed MV based on the at least one MV predictor. In accordance with the present disclosure, video encoder 200 and/or video decoder 300 are further configured to add the reconstructed MV to a history-based motion vector prediction (HMVP) candidate list and add, to the HMVP candidate list, at least a second motion vector associated with constructing (or associated with construction of) the list of candidate motion vectors. Although embodiments of present disclosure may be discussed primarily in the context of utilizing AMVP mode as the inter prediction coding mode, it should be apparent that other inter coding modes such as merge mode, affine inter mode, and/or affine merge mode may also be utilized in conjunction with the technique(s), method(s), and/or mechanism(s) of the present disclosure.

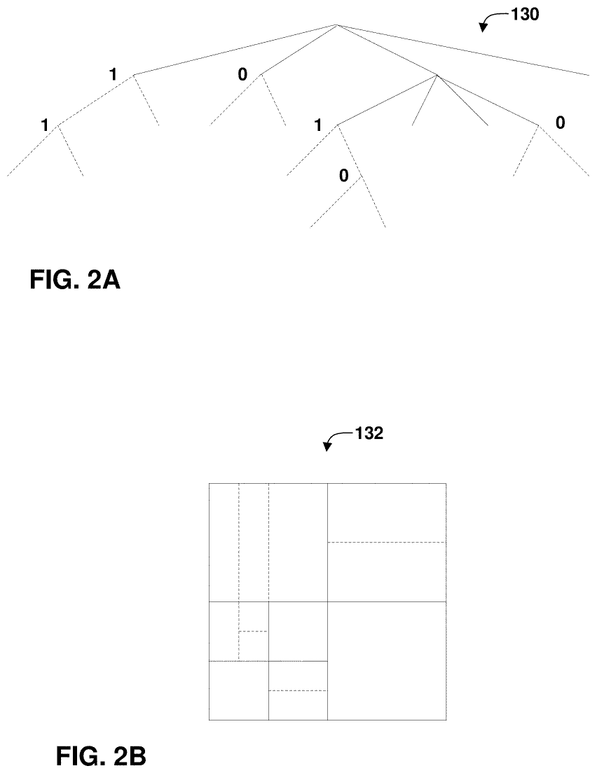

This disclosure may generally refer to “signaling” certain information, such as syntax elements. The term “signaling” may generally refer to the communication of values syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116. FIGS. 2A and 2B are conceptual diagrams illustrating an example quadtree binary tree (QTBT) structure 130 and a corresponding coding tree unit (CTU) 132. The solid lines represent quadtree splitting, and dotted lines indicate binary tree splitting. In each split (e.g., non-leaf) node of the binary tree, one flag is signaled to indicate which splitting type (e.g., horizontal or vertical) is used, where a value of 0 of the flag indicates horizontal splitting, and a value of 1 of the flag indicates vertical splitting in this example. For the quadtree splitting, there is no need to indicate the splitting type, since quadtree nodes split a block horizontally and vertically into 4 sub-blocks of equal size. Accordingly, video encoder 200 may encode, and video decoder 300 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 200 may encode, and video decoder 300 may decode, video data, such as prediction and transform data, for CUs represented by terminal leaf nodes of QTBT structure 130.

In general, CTU 132 of FIG. 2B may be associated with parameters defining sizes of blocks corresponding to nodes of QTBT structure 130 at the first and second levels. These parameters may include a CTU size (representing a size of CTU 132 in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 130 represents such nodes as including the parent node and child nodes having solid lines for branches. If nodes of the first level are not larger than the maximum allowed binary tree root node size (MaxBTSize), they can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 130 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the leaf quadtree node is 128×128, it will not be further split by the binary tree, since the size exceeds the MaxBTSize (i.e., 64×64, in this example). Otherwise, the leaf quadtree node will be further partitioned by the binary tree. Therefore, the quadtree leaf node is also the root node for the binary tree and has the binary tree depth as 0. When the binary tree depth reaches MaxBTDepth (4, in this example), no further splitting is permitted. When the binary tree node has width equal to MinBTSize (4, in this example), it implies no further horizontal splitting is permitted. Similarly, a binary tree node having a height equal to MinBTSize implies no further vertical splitting is permitted for that binary tree node. As noted above, leaf nodes of the binary tree are referred to as CUs, and are further processed according to prediction and transform without further partitioning.

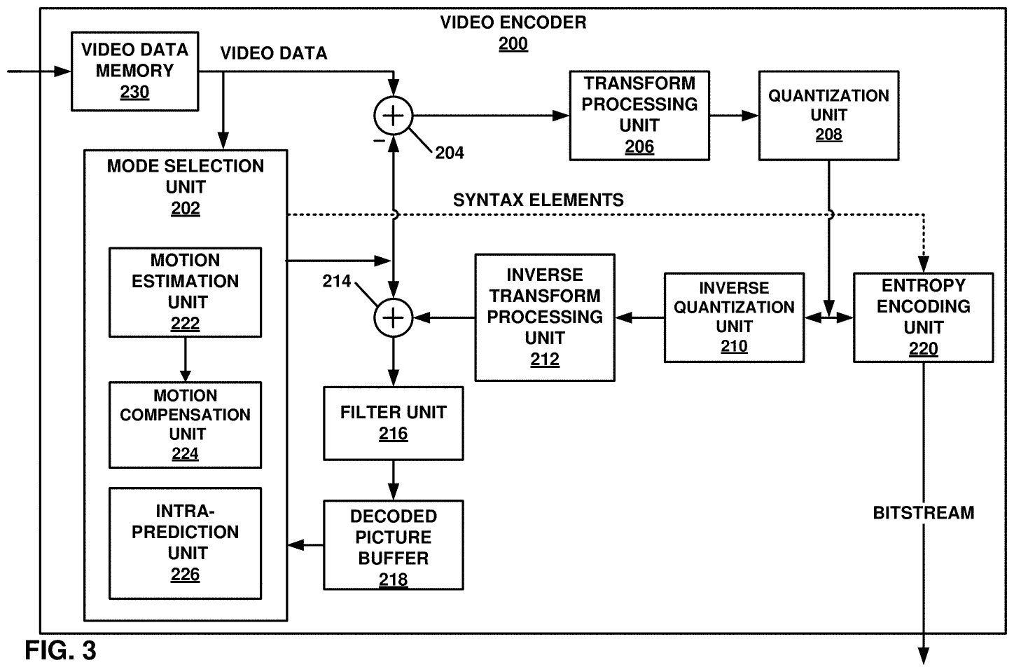

FIG. 3 (is a block diagram illustrating an example video encoder 200 that may perform the techniques of this disclosure such as generation, selection, and/or inclusion of additional history-based motion vector prediction (HMVP) candidates for AMVP coding. FIG. 3 is provided for purposes of explanation and should not be considered limiting of the techniques as broadly exemplified and described in this disclosure. For purposes of explanation, this disclosure describes video encoder 200 in the context of video coding standards such as the HEVC video coding standard and the H.266/VVC video coding standard in development. However, the techniques of this disclosure are not limited to these video coding standards, and are applicable generally to video encoding and decoding including various codec implementations.

In the example of FIG. 3, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units (or components) of the video encoder 200 depicted in FIG. 3 are illustrated to assist with understanding the operations performed by video encoder 200. The units may be implemented as processing circuitry such as fixed-function circuits, programmable circuits, or a combination thereof. Fixed-function circuits refer to circuits that provide particular (e.g., are configured to provide) functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the object code of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 210 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

In accordance with the techniques of this disclosure, motion estimation unit 222 and motion compensation unit 224 may perform inter-prediction and motion vector prediction techniques when coding (e.g., encoding) a block using a particular inter prediction mode such as AMVP mode. For example, as will be explained in more detail below, motion estimation unit 222 and/or motion compensation unit 224 may be configured to code a first block of video data using an advanced motion vector prediction (AMVP) mode of inter prediction coding where coding the first block using the AMVP mode includes motion estimation unit 222 and motion compensation unit 224 being configured to construct a list of candidate motion vectors for coding the first block using the AMVP mode, identify at least one MV predictor from among the list of candidate motion vectors, and generate a reconstructed MV based on the at least one MV predictor. In accordance with the present disclosure, motion estimation unit 222 and/or motion compensation unit 224 are further configured to add the reconstructed MV to a HMVP candidate list and add, to the HMVP candidate list, at least a second motion vector associated with constructing (or associated with construction of) the list of candidate motion vectors.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction.

In examples where mode selection unit does not further partition a CU into PUs, each CU may be associated with a luma coding block and corresponding chroma coding blocks. As above, the size of a CU may refer to the size of the luma coding block of the CU. The video encoder 200 and video decoder 120 may support CU sizes of 2N×2N, 2N×N, or N×2N.

For other video coding techniques such as an intra-block copy mode coding, an affine-mode coding, and linear model (LM) mode coding, as few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 224 are not needed, reconstruction unit 214 may store reconstructed blocks to DPB 218. In examples where operations of filter unit 224 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures using an inter coding mode mentioned above. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding blocks and the chroma coding blocks.

Video encoder 200 represents an example of a device configured to encode video data including a memory configured to store video data, and one or more processing units implemented in circuitry and configured to encode a first block of video data using an advanced motion vector prediction (AMVP) mode of inter prediction coding where encoding the first block using the AMVP mode includes video encoder 200 being configured to construct a list of candidate motion vectors for encoding the first block using the AMVP mode, identify at least one MV predictor from among the list of candidate motion vectors, and generate a reconstructed MV based on the at least one MV predictor. In accordance with the present disclosure, video encoder 200 further configured to add the reconstructed MV to a history-based motion vector prediction (HMVP) candidate list and add, to the HMVP candidate list, at least a second motion vector associated with constructing (or associated with construction of) the list of candidate motion vectors.

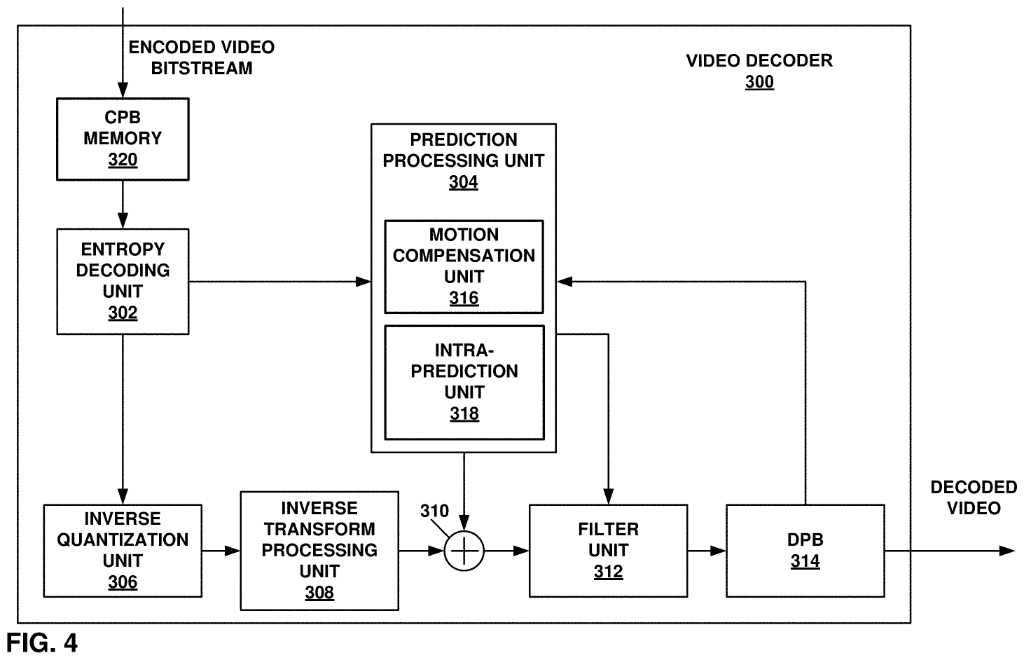

FIG. 4 is a block diagram illustrating an example video decoder 300 that may perform the techniques of this disclosure. FIG. 4 is provided for purposes of explanation and is not limiting on the techniques as broadly exemplified and described in this disclosure. For purposes of explanation, this disclosure describes video decoder 300 is described according to the techniques of H.266/VVC, JEM, and HEVC. However, the techniques of this disclosure may be performed by video coding devices that are configured to other video coding standards.

In the example of FIG. 4, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Prediction processing unit 304 includes motion compensation unit 316 and intra-prediction unit 318. Prediction processing unit 304 may include addition units to perform prediction in accordance with other prediction modes. As examples, prediction processing unit 304 may include a palette unit, an intra-block copy unit (which may form part of motion compensation unit 318), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to executed by processing circuitry of video decoder 300.

The various units (or components) shown in FIG. 4 are illustrated to assist with understanding the operations performed by video decoder 300. The units may be implemented as fixed-function circuits, programmable circuits, or a combination thereof. Similar to FIG. 3, fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 3).

In accordance with the techniques of this disclosure, motion compensation unit 316 may perform inter-prediction and motion vector prediction techniques when coding a block using a inter coding mode such as AMVP mode as described herein. For example, as will be explained in more detail below, motion compensation unit 316 may be configured to decode a first block of video data using an advanced motion vector prediction (AMVP) mode of inter prediction coding where coding the first block using the AMVP mode includes motion compensation unit 316 being configured to construct a list of candidate motion vectors for decoding the first block using the AMVP mode, identify at least one MV predictor from among the list of candidate motion vectors, and generate a reconstructed MV based on the at least one MV predictor. In accordance with the present disclosure, motion compensation unit 316 is further configured to add the reconstructed MV to a history-based motion vector prediction (HMVP) candidate list and add, to the HMVP candidate list, at least a second motion vector associated with constructing (or associated with construction of) the list of candidate motion vectors.

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 3). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures from DPB for subsequent presentation on a display device, such as display device 118 of FIG. 1.

In this manner, video decoder 300 represents an example of a video decoding device including a memory configured to store video data, and one or more processing units implemented in circuitry and configured to decode a first block of video data using an advanced motion vector prediction (AMVP) mode of inter prediction coding where decoding the first block using the AMVP mode includes video decoder 300 being configured to construct a list of candidate motion vectors for decoding the first block using the AMVP mode, identify at least one MV predictor from among the list of candidate motion vectors, and generate a reconstructed MV based on the at least one MV predictor. In accordance with the present disclosure, video decoder 300 is further configured to add the reconstructed MV to a history-based motion vector prediction (HMVP) candidate list and add, to the HMVP candidate list, at least a second motion vector associated with constructing the list of candidate motion vectors.

The CU structure and motion vector prediction in HEVC will now be discussed. In HEVC, the largest coding unit in a slice is called a coding tree block (CTB) or coding tree unit (CTU). A CTB contains a quad-tree the nodes of which are coding units.

The size of a CTB can range from 16×16 to 64×64 in the HEVC main profile (although technically 8×8 CTB sizes can be supported). A coding unit (CU) can be the same size of a CTB, and as small as 8×8. Each coding unit is coded with one mode. When a CU is inter coded, it may be further partitioned into 2 or 4 prediction units (PUs) or become just one PU when further partitioning does not apply. When two PUs are present in one CU, they can be half size rectangles or two rectangle sizes with ¼ or ¾ size of the CU.

Motion Vector Prediction in HEVC

In the HEVC standard, there are two inter prediction modes, named merge (skip is considered as a special case of merge without residual) and AMVP modes, respectively, for a PU.

In AMVP mode, a candidate list of motion vector predictors for each motion hypothesis may be derived based on the coded reference index. This list includes motion vectors of, for example, neighboring blocks that are associated with the same reference index as well as a temporal motion vector predictor which is derived based on the motion parameters of the neighboring block of the co-located block in a temporal reference picture. The chosen motion vectors are signaled by transmitting an index into the candidate list. In addition, the reference index values and motion vector differences are also signaled. In this disclosure, the term motion vector predictor is generally used to refer to any motion vector from which one or more motion vectors are predicted. In some instances, the motion vector predictor and the predicted motion vector may be identical, while in other instances the motion vector predictor and the predicted motion vector may be different. In AMVP mode, for example, the predicted motion vector corresponds to the motion vector predictor plus motion vector difference values. This disclosure also refers to the term directional motion predictor, which generally refers to a motion vector predictor associate with a particular direction (i.e., a particular reference picture list). In the case of bi-prediction, a motion vector predictor may include two directional motion predictors.

In either AMVP or merge mode, video encoder 200 and video decoder 300 may construct and maintain a motion vector (MV) candidate list for multiple motion vector predictors (also referred to as MV predictors). The motion vector(s), as well as reference indices in the merge mode, of the current PU are generated by taking one candidate from the MV candidate list.

The MV candidate list contains up to 5 candidates for the merge mode and only two candidates for the AMVP mode. A merge candidate may contain a set of motion information, e.g., motion vectors corresponding to both reference picture lists (list 0 and list 1) and the reference indices. If a merge candidate is identified by a merge index, the reference pictures are used for the prediction of the current blocks, as well as the associated motion vectors are determined. However, under AMVP mode for each potential prediction direction from either list 0 or list 1, a reference index is explicitly signaled, together with an MV predictor (MVP) index to a particular MV candidate within the MV candidate list, since the AMVP candidate contains only a motion vector. In AMVP mode, the predicted motion vectors can be further refined.

As can be seen above, a merge candidate corresponds to a full set of motion information while an AMVP candidate contains just one motion vector for a specific prediction direction and reference index. The candidates for both modes are derived similarly from the same spatial and temporal neighboring blocks.

Spatial Neighboring Candidates

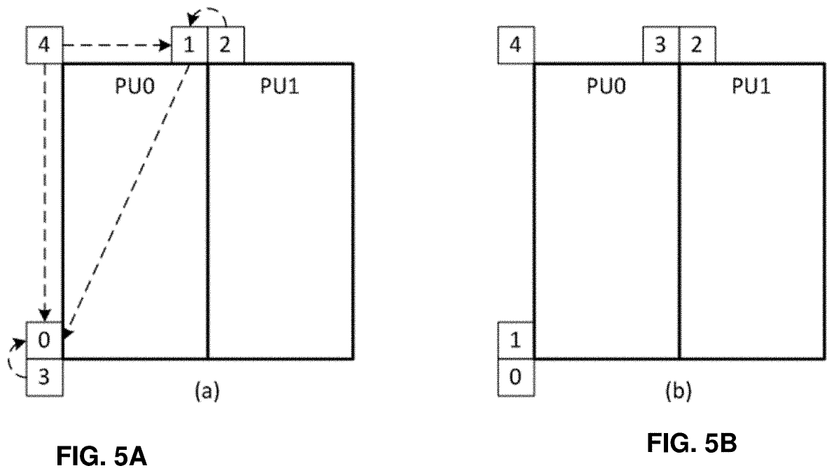

Spatial MV candidates are derived from the neighboring blocks, as shown in FIG. 5A and FIG. 5B, for a specific PU (PU₀), although the techniques for generating the candidates from the blocks differ for merge and AMVP modes.

FIG. 5A is a conceptual diagram showing spatial neighboring candidates for merge mode. FIG. 5B is a conceptual diagram showing spatial neighboring candidates for AMVP mode. In merge mode, up to four spatial MV candidates can be derived in the order shown in FIG. 5A. The order is the following: left (0, A1), above (1, B1), above right (2, B0), below left (3, A0), and above left (4, B2).

In AVMP mode, the neighboring blocks are divided into two groups: a left group including the block 0 and 1, and an above group include the blocks 2, 3, and 4 as shown FIG. 5B. For each group, the potential candidate in a neighboring block referring to the same reference picture as that indicated by the signaled reference index has the highest priority to be chosen to form a final candidate of the group. It is possible that all neighboring blocks do not contain a motion vector pointing to the same reference picture. Therefore, if such a candidate cannot be found, the first available candidate will be scaled to form the final candidate, thus the temporal distance differences can be compensated.

Temporal Motion Vector Prediction in HEVC

A temporal motion vector predictor (TMVP) candidate, if enabled and available, is added into the MV candidate list after spatial motion vector candidates. The process of motion vector derivation for TMVP candidate is the same for both merge and AMVP modes. However, the target reference index for the TMVP candidate in the merge mode is set to 0.

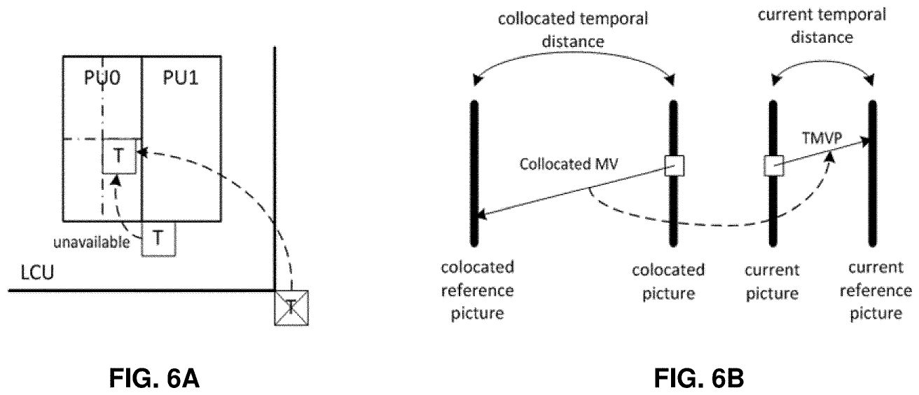

The primary block location for TMVP candidate derivation is the bottom right block outside of the collocated PU, as shown in FIG. 6A as block “T,” to compensate the bias to the above and left blocks used to generate spatial neighboring candidates. However, if that block is located outside of the current CTB row or motion information is not available, the block is substituted with a center block of the PU.

A motion vector for TMVP candidate is derived from the co-located PU of the co-located picture, indicated in the slice level. The motion vector for the co-located PU is called the collocated MV.

Similar to temporal direct mode in H.264/AVC, to derive the TMVP candidate motion vector, the co-located MV may be scaled to compensate the temporal distance differences, as shown in FIG. 6B.

Several aspects of exemplary inter coding modes, for example, merge mode and AMVP mode are described below.

Motion Vector Scaling:

It is assumed that the value of motion vectors is proportional to the distance of pictures in the presentation time. A motion vector associates two pictures: the reference picture and the picture containing the motion vector (namely the containing picture). When a motion vector is utilized to predict the other motion vector, the distance of the containing picture and the reference picture is calculated based on the Picture Order Count (POC) values of the respective pictures.

For a motion vector to be predicted, both the motion vector's associated containing picture and associated reference picture may be different. Therefore, a new distance (based on POC values) is calculated and the motion vector is scaled based on these two POC distances. For a spatial neighboring candidate, the containing pictures for the two motion vectors are the same, while the reference pictures are different. In HEVC, motion vector scaling applies to both TMVP and AMVP for spatial and temporal neighboring candidates.

Artificial Motion Vector Candidate Generation:

If a motion vector candidate list is not complete (e.g., less than a predetermined number), artificial motion vector candidates are generated and inserted at the end of the list (e.g., after the other available motion vector candidates) until the list has the prescribed number of candidates.

In merge mode, there are two types of artificial MV candidates: a combined candidate derived only for B-slices and zero candidates used only for AMVP if the first type does not provide enough artificial candidates.

For each pair of candidates that are already in the candidate list and have necessary motion information, bi-directional combined motion vector candidates are derived by a combination of the motion vector of the first candidate referring to a picture in the list 0 and the motion vector of a second candidate referring to a picture in the list 1.

Pruning Process for Candidate Insertion:

Candidates from different blocks may happen to be the same, which decreases the efficiency of a merge/AMVP candidate list. A pruning process is applied to address this problem. The pruning process compares one candidate against the others in the current candidate list to avoid inserting identical candidates. To reduce the complexity, only limited numbers of pruning processes are applied instead of comparing each potential candidate with all the other existing candidates.

History-Based Motion Prediction

History-based motion vector prediction (HMVP) (e.g., as described in L. Zhang, K. Zhang, H. Liu, Y. Wang, P. Zhao, and D. Hong, “CE4-related: History-based Motion Vector Prediction”, JVET-K0104, July 2018) involves keeping (e.g., maintaining or storing in memory) a table for previously decoded motion vectors as HMVP candidates. HMVP allows (e.g., is configured to enable) each block to find the respective block's MV predictor from a list of MVs decoded from the past (e.g., previously decoded) in addition to those immediately adjacent causal neighboring motion fields. The table with multiple HMVP candidates is maintained during the encoding/decoding process.

Video encoder 200 and/or video decoder 300 updates the table when coding a non-affine inter-coded block. The retrieved motion vector (e.g., reconstructed motion vector) will be added (e.g., inserted or included) by, for example, video encoder 200 and/or video decoder 300 as a new HMVP candidate to the last entry of the buffer (e.g., the memory storing the table). A First-In-First-Out (FIFO) or constraint FIFO rule is applied, by the video encoder 200 and/or the video decoder 300, to the table to add or remove candidates in the table. The candidates within the table can be used for candidate lists for various inter coding modes. For example, the candidates within the table can be used for candidates for a merge candidate list and/or an AMVP candidate list. The artificial motion vector, including combined and zero candidates, can be replaced by the candidates in the table.

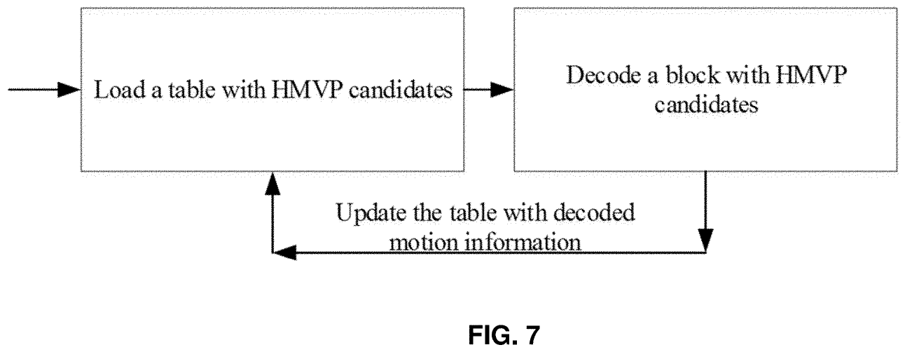

In some examples, the table is emptied when a processing a new slice. If the block is coded with merge (or skip) or AMVP mode, video encoder 200 and/or video decoder 300 constructs a merge candidate list or AMVP candidate list for the block. If the available candidate number in the list is less than the pre-defined maximum limit of candidates allowed for the candidate list, video encoder 200 and/or video decoder 300 uses the candidates in the table to fill out (e.g., completely fill) the candidate list. If there is an non-affine, inter-coded block, its motion vector is added to the last entry of the table. The table will be updated after adding new candidates. The overall coding flow is depicted in FIG. 7. The coding flow depicted in FIG. 7 is merely exemplary; the overall coding flow may be applicable to various inter coding modes such as merge mode, AMVP mode, affine inter mode, and/or affine merge mode that may utilize history-based motion vector prediction.

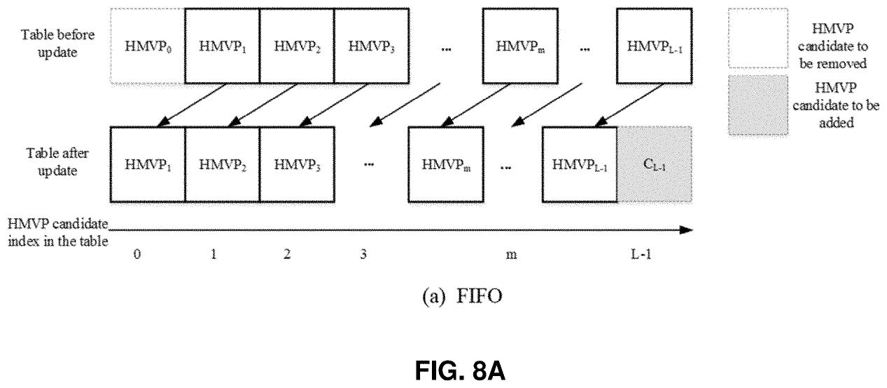

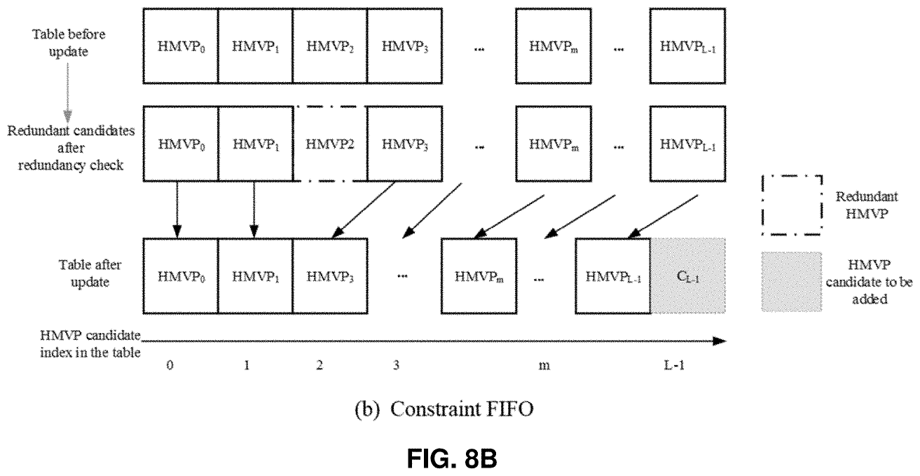

Assuming the table has a size of (e.g., configured to store) S HMVP candidates, the First-In-First-Out (FIFO) rule in FIG. 8A is applied when adding a new candidate to the table containing S number of HMVP candidates. Video encoder 200 and/or video decoder 300 adds the new candidate to the final entry of the FIFO and removes the candidate in the first entry. As such, the table always contains the S newest (e.g., most recent) candidates such that comparatively older (e.g., less recent) candidates are removed.

The FIFO may cause the table to keep redundant candidates. Video encoder 200 and/or video decoder 300 may use a constraint FIFO, as shown in FIG. 8B, to address the problem of redundant candidates. Before adding the new candidate, video encoder 200 and/or video decoder 300 may remove identical candidates in the table. In other words, video encoder 200 and/or video decoder 300 may remove a candidate from the table when the table includes candidates that are duplicates of (or identical to) one another. The candidates that were positioned in the table after the duplicate candidate (prior to removal of the duplicate candidate) will be moved forward (e.g., progressed forward within the table) to fill the empty entry. Then the new candidate will be added to the last entry of the table subsequent to these remaining candidates within the table.

HMVP candidates may be used in the merge candidate list construction process. All HMVP candidates from the last entry to the first entry in the table may be inserted after the TMVP candidate. Pruning by may be applied, for example, by video encoder 200 and/or video decoder 300 to the HMVP candidates. HMVP candidates will continue being inserted to the merge candidate list until the merge candidate number reaches the maximum limit.

Similarly, HMVP candidates could also be used, by video encoder 200 and/or video decoder 300, in the AMVP candidate list construction process. The last K HMVP candidates may be inserted to the AMVP candidates after TMVP candidate. In one example, the inserted HMVP candidate must have the same reference picture as the that of AMVP. Pruning may also be applied on the HMVP candidates.

In current implementations, when operating according to HMVP, video encoders and/or video decoders only add (e.g., are configured to only include) a reconstructed MV of, for example, an inter coded block (e.g., an AMVP mode block (i.e., a block coded using AMVP)) as a MV candidate to the HMVP candidates stored in the table. When coding a block using, for example, AMVP, only one (e.g., a single) MV candidate is selected, by a video coder, from among all available MV candidates within the AMVP candidate list to serve as a MV predictor (MVP) for predicting the reconstructed MV. Currently, video coders discard the remaining MV candidates (e.g., the MV candidates other than the selected MV candidate mentioned above) of the AMVP candidate list (i.e., an inter coding mode candidate list) and do not include these remaining MV candidates as HMVP candidates that are stored/updated to the table. However, these remaining MV candidates that are discarded may beneficial and provide increased coding efficiency/performance for purposes of serving as MV candidates for coding other inter coded blocks (e.g., AMVP blocks). Furthermore, the derivation process (e.g., scaling of TMVP and the like) of these eventually discarded AMVP candidates, requires significant resources (e.g., time and/or computation) such that discarding these AMVP candidates is wasteful and therefore not ideal.

To address the problems mentioned above, following techniques for HMVP table updating are proposed in which a video coder processes in association with an inter coded mode block, for example, an AMVP mode coded block, at least one additional MV for inclusion as a HMVP candidate in addition to a reconstructed MV derived from a AMVP candidate selected from an AMVP candidate list associated with coding the AMVP mode block. Any combination of the techniques below may be applied by a video coder (e.g., video encoder 200 and/or video decoder 300) alone or, alternatively, in complete (or partial) combination with one another.

Furthermore, as previously mentioned, although embodiments of present disclosure may be discussed primarily in the context of utilizing AMVP mode as the particular inter prediction coding mode, it should be readily apparent that other inter coding modes such as merge mode, affine inter mode, and/or affine merge mode may also be utilized in conjunction with the technique(s), method(s), and/or mechanism(s) of the present disclosure.

For example, in one or more implementations, for an AMVP mode coded block (i.e., a block coded using AMVP mode, or simply, AMVP), video encoder 200 and/or video decoder 300 may be configured to select (e.g., identify or determine) one (e.g., a single) AMVP candidate (also referred to herein as “MV candidate”) among an AMVP candidate list to utilize as a MVP for reconstructing a MV for use in coding the AMVP block. Video encoder 200 and/or video decoder 300 may then add the reconstructed MV as a HMVP candidate within the table of HMVP candidates stored in memory (e.g., a buffer). In various examples, in addition to the reconstructed MV, video encoder 200 and/or video decoder 300 may additionally update the HMVP table to include one or more MV candidates (e.g., one or more AMVP candidates other than the AMVP candidate selected to be the MVP) from the AMVP candidate list of the AMVP coded block. For example, the additional one or more AMVP candidates included by video encoder 200 and/or video decoder 300 as HMVP candidate(s) may be selected from among the MV candidate(s) within the AMVP candidate list that were not selected to be the MVP. In other examples, the additional one or more AMVP candidates may comprise the AMVP candidate selected as the MVP for coding the AMVP coded block.

In yet other examples of the present disclosure, for an AMVP coded block, video encoder 200 and/or video decoder 300, may update a HMVP table (i.e., include as additional HMVP candidates) with any number (e.g., 1 to 5) of the spatial neighboring MVs (if available) that video encoder 200 and/or video decoder 300 may have utilized for deriving spatial AMVP candidates for coding the AMVP coded block. In various embodiments, these additional HMVP candidate(s) would be added in addition to the reconstructed MV used to code the AMVP coded block.

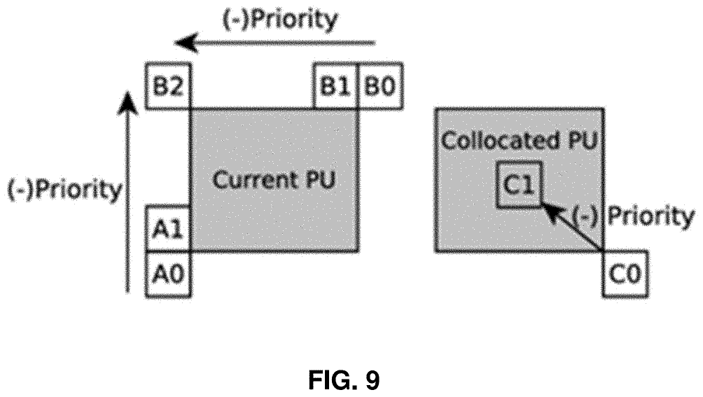

FIG. 9 illustrates an exemplary selection priority among spatial neighboring MVs and temporal neighboring MVs relative to a current PU/collocated PU that may be implemented by video encoder 200 and/or video decoder 300 when updating the HMVP table with additional HMVP candidates other than the reconstructed MV. In some examples, video encoder 200 and/or video decoder 300 may select (or choose) a fixed set (e.g., a predetermined number or prioritized sequence) of spatial neighboring MVs to use for updating the HMVP candidates. For example, with reference to FIG. 9, one fixed spatial neighboring MV (e.g., a MV associated with block A1) may be selected then added into the HMVP candidates. In yet another example, two fixed spatial neighboring MVs (e.g., MVs associated with blocks A1 and B1) may be selected and then added into the HMVP candidates.

In other examples, video encoder 200 and/or video decoder 300 may be configured to evaluate/assess one or more criteria, conditions, and/or rules as well as configured to perform one or more determinations in order to adaptively select (determine or identify), for example, a set of spatial neighboring MV(s) to additionally be added into the HMVP candidates. For example, for a particular inter mode block (e.g., an AMVP coded block), if the width of the particular inter mode block is determined to be greater than or equal to the height of the particular inter mode block, a preconfigured number of MV(s) or MV(s) associated with specific blocks (e.g., B2 and B0) may be used for updating the HMVP table (e.g., buffer). Otherwise, in this example, if the width of the particular inter mode block is determined, by video encoder 200 and/or video decoder 300, not to be greater than or equal to (i.e., less than) the height of the particular inter mode block, alternative MVs (e.g., MVs associated with blocks B2 and A0) may be added as HMVP candidates.

As shown in FIG. 9 and as previously discussed in connection with FIGS. 6A and 6B, video encoder 200 and/or video decoder 300 may process two temporal neighboring MVs for deriving temporal AMVP candidates. A such, in some examples of the present disclosure, for an AMVP coded block, video encoder 200 and/or video decoder 300, may update a HMVP table (i.e., include as additional HMVP candidates stored in memory, for example, a buffer) with a number (e.g., 1 or 2) of the temporal neighboring MVs (if available) that video encoder 200 and/or video decoder 300 may have utilized for deriving TMVP candidates for coding the AMVP coded block. In various embodiments, these additional HMVP candidate(s) would be added in addition to the reconstructed MV used to code the AMVP coded block. The number of temporal neighboring MVs used to update the HMVP table may be predetermined by video encoder 200 and/or video decoder 300 and/or selected based on some condition, criteria, and/or evaluation by video encoder 200 and/or video decoder 300. For example, with reference to FIG. 9, one fixed, temporal neighboring MV (e.g., a MV associated with block C0) may be selected then added into the HMVP candidates. In yet another example, two fixed, temporal neighboring MVs (e.g., MVs associated with blocks C0 and C1) may be selected and then added into the HMVP candidates.

In other examples, video encoder 200 and/or video decoder 300 may be configured to evaluate/assess one or more criteria, conditions, and/or rules as well as configured to perform one or more determinations in order to adaptively select (determine or identify), for example, a set of temporal neighboring MV(s) to additionally be added into the HMVP candidates. For example, for a particular inter mode block (e.g., an AMVP coded block), video encoder 200 and/or video decoder 300 may determine whether the MV (e.g., TMVP) associated with block C0 is available. If available, video encoder 200 and/or video decoder 300 will add the MV associated with block C0 as an additional HMVP candidate. If the MV associate with block C0 is not available, video encoder 200 and/or video decoder 300 may elect to add the MV associated with block C1 (if available) as an additional HMVP candidate.

As discussed above, if a motion vector candidate list (e.g., an AMVP candidate list) is not complete artificial motion vector candidates are generated and inserted at the end of the candidate list until the list has the prescribed number of candidates. For an AMVP coded block, video encoder 200 and/or video decoder 300 may construct an AMVP candidate list that contains one or more artificial zero candidates for filling empty entries in the AMVP candidate list. With respect to each of the aforementioned embodiments/implementations, video encoder 200 and/or video decoder 300 may adaptively determine whether to add any artificial zero candidates as HMVP candidates.

In other implementations of the aforementioned embodiments discussing different mechanism for the inclusion of additional HMVP candidates, video encoder 200 and/or video decoder 300 may be configured not to update the HMVP table with any artificial zero candidates.

As discussed above, HMVP candidates stored within the HMVP table may used, by video encoder 200 and/or video decoder 300, during construction (i.e., generation) of an AMVP candidate list. As such, in conjunction with any (or each) of the examples/embodiments discussed in this disclosure that provides a mechanism(s) for the inclusion of additional HMVP candidates derived based on coding an AMVP coded block, the resulting updated HMVP table including additional HMVP candidates may be used by video encoder 200 and/or video decoder 300, during construction (i.e., generation) of an AMVP candidate list for another inter coded block (e.g., a second AMVP coded block).

The techniques of this disclosure allow for more HMVP table updating. Adding, to the HMVP table, these additional candidates derived based on coding of an AMVP coded block keeps the table updating. Thus, the table still keeps newer motion vectors with a higher probability for future prediction or merge operation.

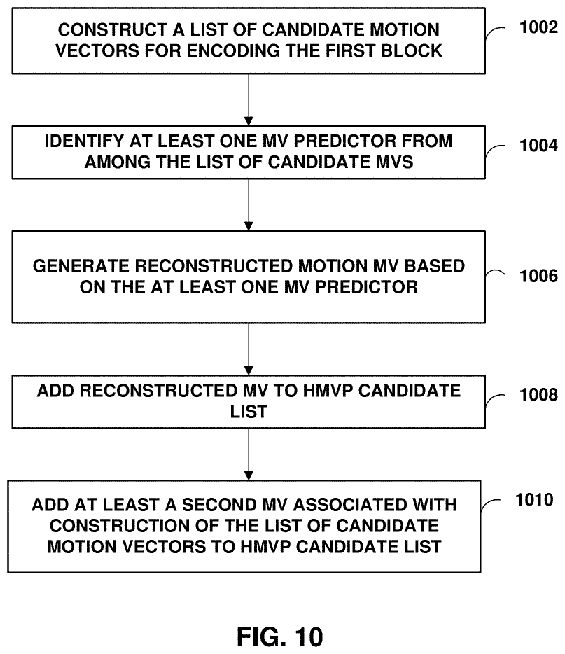

FIG. 10 is a flowchart illustrating example operations of a video encoding device (e.g., video encoder 200) operating in accordance with the mechanism(s) and/or technique(s) of this disclosure. For purposes of explanation, the flowchart of FIG. 10 is described below as being performed by the video encoder 200 and the components thereof as discussed in FIGS. 1 and 3. However, it should be understood that other devices may be configured to perform the flowchart of FIG. 10 or a similar method. Furthermore, the operations of the video encoder 200 described in conjunction with FIG. 3 are merely a subset of the operations video encoder 20 is configured to perform in accordance with the present disclosure. For example, video encoder 200 is configured to determine, process, and/or signal additional data (e.g., syntax elements) within an encoded bitstream and perform other operations (e.g., prediction of a current picture and POC-based, motion vector scaling) described within the disclosure.

In accordance with one or more techniques of this disclosure, video encoder 200 (e.g., mode selection unit 202 and components thereof such as motion estimation unit 222 and/or motion compensation unit 224) may encode a first block of video data using a particular inter prediction coding mode. For example, as discussed in detail above, video encoder 200 may, for example, utilize AMVP mode as the inter prediction coding mode or may determine that another inter coding mode such as merge mode, affine inter mode, or affine merge mode may best suited to encode the first block.

During the inter prediction encoding process, video encoder 200 (e.g., mode selection unit 202 and in some implementations, specifically motion estimation unit 222) may construct a list of candidate motion vectors for encoding the first block using the selected inter prediction coding mode (1002). Video encoder 200 may identify (or select) at least one motion vector candidate from among the list of candidate motion vectors (1004) to utilize as a motion vector predictor for generating a reconstructed motion vector for use in encoding the first block (1006). Video encoder 200 may then add the reconstructed motion vector as a HMVP candidate within the table of HMVP candidates stored in memory (1008). In addition to the reconstructed motion vector, video encoder 200 may further update the HMVP table to include at least a second motion vector candidate (e.g., a motion vector candidate other than the at least one motion vector candidate selected to be the motion vector predictor) from the list of candidate motion vectors for encoding the first block using the selected inter prediction coding mode in accordance with the one or more embodiments of the present disclosure (1010).

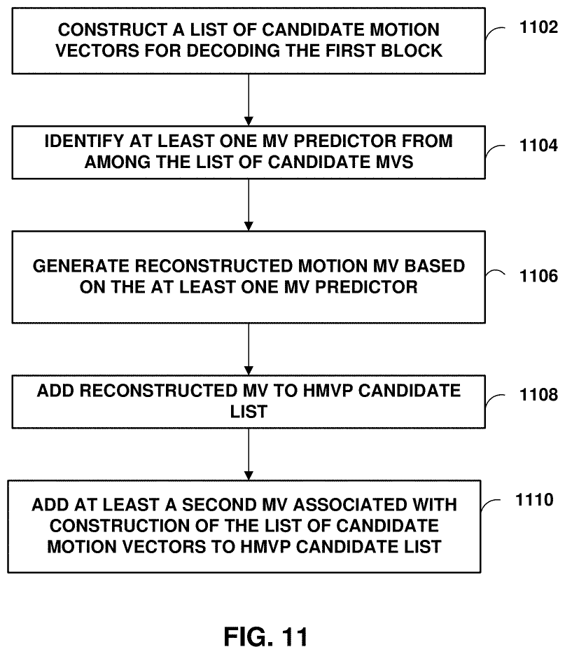

FIG. 11 is a flowchart illustrating example operations of a video encoding device (e.g., video decoder 300) operating in accordance with the mechanism(s) and/or technique(s) of this disclosure For purposes of explanation, the flowchart of FIG. 10 is described below as being performed by video decoder 300 and the components thereof as discussed in FIGS. 1 and 4. However, it should be understood that other devices may be configured to perform the flowchart of FIG. 11 or a similar method. Furthermore, the operations of the video decoder 300 described in conjunction with FIG. 4 are merely a subset of the operations video decoder 300 is configured to perform in accordance with the present disclosure. For example, video decoder 30 is configured to parse and process additional data (e.g., syntax elements) from a bitstream and perform other operations (e.g., prediction of a current picture and POC-based, motion vector scaling) described throughout the disclosure.

In accordance with one or more techniques of this disclosure, video decoder 300 (e.g., prediction processing unit 304 and components thereof such as motion compensation unit 316) may decode a first block of video data using a particular inter prediction coding mode. For example, as discussed in detail above, video decoder 300 may, for example, utilize AMVP mode as the inter prediction coding mode or may determine (e.g., based on explicit signalling or based on a determination without explicit signaling) that another inter coding mode such as merge mode, affine inter mode, or affine merge mode may best suited to decode the first block.

During the inter prediction decoding process, video decoder 300 (e.g., prediction processing unit 304 and in some implementations, specifically motion compensation unit 316) may construct a list of candidate motion vectors for decoding the first block using the selected inter prediction coding mode (1102). Video decoder 300 may identify (or select) at least one motion vector candidate from among the list of candidate motion vectors (1104) to utilize as a motion vector predictor for generating a reconstructed motion vector for use in decoding the first block (1106). Video decoder 300 may then add the reconstructed motion vector as a HMVP candidate within the table of HMVP candidates stored in memory (1108). In addition to the reconstructed motion vector, video decoder 300 may further update the HMVP table to include at least a second motion vector candidate (e.g., a motion vector candidate other than the at least one motion vector candidate selected to be the motion vector predictor) from the list of candidate motion vectors for decoding the first block using the selected inter prediction coding mode in accordance with the one or more embodiments of the present disclosure (1110).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
coding a first block of video data using an inter prediction coding mode, wherein coding the first block using the inter prediction coding mode comprises:
constructing a list of candidate motion vectors for coding the first block using the inter prediction coding mode,
identifying at least one motion vector predictor from among the list of candidate motion vectors, and
generating a reconstructed motion vector based on the at least one motion vector predictor;
adding the reconstructed motion vector to a history-based motion vector prediction (HMVP) candidate list; and
adding, to the HMVP candidate list, a second motion vector associated with construction of the list of candidate motion vectors.

2. The method of claim 1 further comprising:
constructing, based on the HMVP candidate list, a second list of candidate motion vectors for coding a second block; and
coding the second block based on a motion vector identified from among the second list of candidate motion vectors.

3. The method of claim 2 further comprising inter prediction coding at least one of the first block or the second block using at least one of advanced motion vector prediction (AMVP) mode, merge mode, affine inter mode, or affine merge mode.

4. The method of claim 2, wherein coding the second block based on the motion vector identified from among the second list of candidate motion vectors comprises deriving a motion vector predictor based on the motion vector identified from among the second list of candidate motion vectors.

5. The method of claim 1 further comprising deriving the second motion vector, wherein deriving the second motion vector comprises at least one of:
identifying the second motion vector from among the list of candidate motion vectors; or
deriving the second motion vector from motion information associated with at least one of a spatial neighboring block of the first block or a temporal neighboring block of the first block.

6. The method of claim 5 further comprising not deriving the at least the second motion vector from an artificial candidate or a zero motion vector derived during coding of the first block.

7. The method of claim 1 further comprising adding the second motion vector as a new HMVP candidate as a last entry of a buffer storing the HMVP candidate list.

8. The method of claim 7, wherein the buffer is at least one of a First-In-First-Out (FIFO) buffer or a constraint FIFO buffer.

9. A coding device for encoding or for decoding video data, the coding device comprising:
a buffer memory configured to store pictures of the video data; and
at least one processor in communication with the buffer memory, the at least one processor being implemented in circuitry and configured to:
construct a list of candidate motion vectors for coding a first block using an inter prediction coding mode;
identify at least one motion vector predictor from among the list of candidate motion vectors;
generate a reconstructed motion vector based on the at least one motion vector predictor;
add the reconstructed motion vector to a history-based motion vector prediction (HMVP) candidate list; and
add, to the HMVP candidate list, a second motion vector associated with construction of the list of candidate motion vectors.

10. The coding device of claim 9 wherein the at least one processor is further configured to:
construct, based on the HMVP candidate list, a second list of candidate motion vectors for coding a second block; and
code the second block based on a motion vector identified from among the second list of candidate motion vectors.

11. The coding device of claim 10 wherein the at least one processor is further configured to inter prediction code at least one of the first block or the second block using at least one of advanced motion vector prediction (AMVP) mode, merge mode, affine inter mode, or affine merge mode.

12. The coding device of claim 10 wherein the at least one processor is further configured to derive a motion vector predictor based on the motion vector identified from among the second list of candidate motion vectors.

13. The coding device of claim 10 wherein the at least one processor is further configured to:
identify the second motion vector from among the list of candidate motion vectors; or
derive the second motion vector from motion information associated with at least one of a spatial neighboring block of the first block or a temporal neighboring block of the first block.

14. The coding device of claim 13 wherein the at least one processor is further configured to not derive the at least the second motion vector from an artificial candidate or a zero motion vector derived during coding of the first block.

15. The coding device of claim 13 wherein the at least one processor is further configured to add the second motion vector as a new HMVP candidate as a last entry of a buffer storing the HMVP candidate list.

16. The coding device of claim 15 wherein the buffer is at least one of a First-In-First-Out (FIFO) buffer or a constraint FIFO buffer.

17. A computer-readable storage medium storing instructions that, when executed, cause at least one processor configured to code video data to:
construct a list of candidate motion vectors for coding a first block using an inter prediction coding mode;
identify at least one motion vector predictor from among the list of candidate motion vectors;
generate a reconstructed motion vector based on the at least one motion vector predictor;
add the reconstructed motion vector to a history-based motion vector prediction (HMVP) candidate list; and
add, to the HMVP candidate list, a second motion vector associated with construction of the list of candidate motion vectors.

18. The computer-readable storage medium of claim 17, further storing instructions that, when executed, cause the at least one processor configured to code the video data to:
construct, based on the HMVP candidate list, a second list of candidate motion vectors for coding a second block; and
code the second block based on a motion vector identified from among the second list of candidate motion vectors.

19. The computer-readable storage medium of claim 18, further storing instructions that, when executed, cause the at least one processor configured to code the video data to inter prediction code at least one of the first block or the second block using at least one of advanced motion vector prediction (AMVP) mode, merge mode, affine inter mode, or affine merge mode.

20. The computer-readable storage medium of claim 18, further storing instructions that, when executed, cause the at least one processor configured to code the video data to derive a motion vector predictor based on the motion vector identified from among the second list of candidate motion vectors.

21. The computer-readable storage medium of claim 17, further storing instructions that, when executed, cause the at least one processor configured to code the video data to:
identify the second motion vector from among the list of candidate motion vectors; or
derive the second motion vector from motion information associated with at least one of a spatial neighboring block of the first block or a temporal neighboring block of the first block.

22. The computer-readable storage medium of claim 21, further storing instructions that, when executed, cause the at least one processor configured to code the video data to not derive the at least the second motion vector from an artificial candidate or a zero motion vector derived during coding of the first block.

23. The computer-readable storage medium of claim 17, further storing instructions that, when executed, cause the at least one processor configured to code the video data to add the second motion vector as a new HMVP candidate as a last entry of a buffer storing the HMVP candidate list.

24. An apparatus configured to encode or decode video data, the apparatus comprising:
means for constructing a list of candidate motion vectors for coding a first block using an inter prediction coding mode;
means for identifying at least one motion vector predictor from among the list of candidate motion vectors;
means for generating a reconstructed motion vector based on the at least one motion vector predictor;
means for adding the reconstructed motion vector to a history-based motion vector prediction (HMVP) candidate list; and
means for adding, to the HMVP candidate list, a second motion vector associated with construction of the list of candidate motion vectors.

25. The apparatus of claim 24 further comprising:
means for constructing, based on the HMVP candidate list, a second list of candidate motion vectors for coding a second block; and
means for coding the second block based on a motion vector identified from among the second list of candidate motion vectors.

26. The apparatus of claim 25 further comprising means for inter prediction coding at least one of the first block or the second block using at least one of advanced motion vector prediction (AMVP) mode, merge mode, affine inter mode, or affine merge mode.

27. The apparatus of claim 25 further comprising means for deriving a motion vector predictor based on the motion vector identified from among the second list of candidate motion vectors.

28. The apparatus of of claim 24 further comprising means for identifying the second motion vector from among the list of candidate motion vectors or means for deriving the second motion vector from motion information associated with at least one of a spatial neighboring block of the first block or a temporal neighboring block of the first block.

29. The apparatus of claim 28 further comprising means for not deriving the at least the second motion vector from an artificial candidate or a zero motion vector derived during coding of the first block.

30. The apparatus of claim 24 further comprising means for adding the second motion vector as a new HMVP candidate as a last entry of a buffer storing the HMVP candidate list.
